(19) United States
(12) Patent Application Publication
(10) Pub. No.: US 2012/0260488 A1
(43) Pub. Date: Oct. 18, 2012

(54) FLANGE CONNECTOR AND GASKET ASSEMBLY

(76) Inventor: Michael Graham, Elmira, NY (US)

(21) Appl. No.: 13/088,753

(22) Filed: Apr. 18, 2011

(51) Int. Cl. F16L 21/035; B23P 11/00; F16L 23/02

(52) U.S. Cl. 29/525.01; 285/374; 285/363

(57) ABSTRACT

A flange connector and gasket assembly for connecting and sealing duct sections includes a tubular member having an inner end incrementally smaller than its outer end, a gasket-seating trough adjacent to the inner end for receiving a sealing gasket, and an annular flange, extending radially outward from the outer end of the tubular member. The outer perimeter of the annular flange has a rolled edge rolled back toward the inner end of the tubular member, and a sealing gasket secured to the gasket-seating trough of the tubular member for sealing the duct section to be connected. The sealing gasket includes a substantially flat base portion, preferably of J-shaped or L-shaped cross-section, and a flexible, preferably hollow sealing portion of substantially circular cross-sectional shape affixed to and extending radially outward from the base portion for engagement with an outer end of the duct section to be connected and sealed.

### BACKGROUND OF THE INVENTION

1. Field of the Invention

The invention pertains to the field of interconnecting heating, ventilation and air conditioning (HVAC) ducting sections. More particularly, the invention pertains to an improved flange connector and gasket assembly for sealing connections between duct sections.

2. Description of Related Art

Various joint assemblies are known for the connection of the ends of adjacent rectangular, circular, and oval HVAC duct sections. Typically, such joint assemblies generally comprise one or more connections, wherein a first tubular member (such as, e.g., a round or round-oval duct section, or connector therefore), having an outside diameter incrementally less than an inside diameter of a second tubular member, is engaged with the second tubular member by inserting a portion of an end of the first tubular member into a portion of an end of the second tubular member.

In addition, a variety of means are well known for fastening the connections between the ends of adjacent tubular duct sections. One such commonly employed means comprises first and second connectors, one connector attached to each duct section. A flange extends from each connector, and the flanges of the two connectors are fastened together, thereby making the connection. Each connector comprises a tubular member having an inside diameter incrementally less (or greater) than an inside (or outside) diameter of a round or round oval duct. Typically, a radially directed annular flange extends from the tubular member. The flanges of the first and second connectors typically are secured together by a plurality of fasteners distributed about the flange. A washer or gasket frequently is carried between the flanges, to improve the seal.

Numerous other methods are known for connecting and sealing the connections between the ends of adjacent duct sections. For example, U.S. Pat. Nos. 6,301,781, 6,289,706, and 5,983,496 disclose methods of making circular and oval flanged rings, for connecting and sealing circular and oval duct sections. U.S. Pat. No. 5,129,690 discloses an apparatus for connecting and sealing the ends of oval duct sections. U.S. Patent Publication No. 20020124614A1 discloses a flanged connector for HVAC ducting.

U.S. Patent Publication No. 20020140231A1 discloses an apparatus for connecting and sealing duct sections, adapted for connecting and sealing round ducts, round oval ducts, and other commonly used ducts. The apparatus includes first and second connectors. Each connector includes a tubular member having an outside diameter that is incrementally smaller than the inside diameter of the duct to which it is attached. An O-ring carried in an O-ring channel defined in the tubular member makes an air-tight seal with the duct. A radially directed annular flange extends outwardly from an outer end of the tubular member. An outer perimeter of the flange forms a rolled edge. A gasket may be carried between the outer surfaces of adjacent flanges of first and second connectors associated with first and second ducts to be joined. Duct sealer may also be carried between the outer surfaces, with or without a gasket.

U.S. Pat. No. 6,533,332 discloses a sealing gasket for connecting a tubular fitting to a pipe. U.S. Pat. No. 6,457,718 discloses a stepped, stretchable gasket for a pipe joint between mating bell and spigot ends of a metal pipe joint. U.S. Pat. No. 6,431,609 discloses a pipe connector and seal for ventilation ducts, consisting of a U-shaped sealing ring retained by a band on the entering pipe. U.S. Pat. No. 6,427,309 discloses a compression seal consisting of an O-ring set into a retaining groove on an outer pipe fitting. The inner fitting carries a flange, which prevents the sharp front edge of the inner fitting from damaging the O-ring. U.S. Pat. No. 5,213,374 discloses a coupling ring comprising an inner duct segment or sleeve over which there are fit two duct segments to be joined. The ends of each of the outer duct segments engage a bead of sealing material. U.S. Pat. No. 5,094,467 discloses a gasket for placement within an outer pipe to be joined. The gasket is characterized by a plurality of locking elements embedded within the gasket for bearing against the outer surface of the male pipe end. U.S. Pat. No. 5,024,454 discloses an annular seal for heat and air conditioning ducts for aircraft. The seal is carried on flanges disposed on the male pipe end or the female pipe end. In an alternative embodiment, a double-beaded seal is retained within complimentary circumferential grooves formed on the female pipe end.

Unfortunately, the means known in the prior art for sealing the connection between duct sections suffer from several problems. For example, the joints between adjacent duct sections may be misaligned, poorly sealed or leak. In addition, errors can be made when gaskets or sealants are applied in the field on the job site. Furthermore, in some applications where duct sealer is used, excess duct sealer is squeezed from between the flanges as the fasteners are tightened, and tends to foul the perimeter of the apparatus. Thus, there is a need in the art for an improved apparatus for sealing adjacent duct sections that can overcome these and other disadvantages of the prior art.

### SUMMARY OF THE INVENTION

Briefly stated, a flange connector and gasket assembly for connecting and sealing duct sections includes a tubular member having an inner (male) end that is incrementally smaller than the inside diameter of the outer (female) end of a duct section to be joined and sealed, and a gasket-seating trough adjacent to the inner end for receiving a sealing gasket. An annular flange extends radially outward from the outer end of the tubular member, the outer perimeter of the annular flange having a rolled edge that is rolled back toward the inner end of the tubular member. A sealing gasket is secured to the gasket-seating trough of the tubular member for sealing the duct section to be connected. The sealing gasket has a substantially flat base portion, preferably including a substantially I-shaped, J-shaped or L-shaped cross-section, and a flexible hollow sealing portion of substantially circular cross-sectional shape affixed to and extending radially outward from the flat base portion for engagement with an outer end of the duct section to be connected and sealed.

In a preferred embodiment, the sealing gasket base portion and the flexible hollow sealing portion comprise materials having different hardness, the flexible hollow sealing portion preferably being softer than the base portion. Preferably the sealing gasket is permanently secured to the gasket-seating trough of the tubular member by a hem that crimps the inner edge of the tubular member onto the edge of the sealing gasket flat base portion.

A flange connector and gasket assembly system for connecting and sealing duct sections includes first and second flange connector and gasket assemblies in accordance with the invention, wherein the inner (male) end of each first and second flange connector and gasket assembly is fitted into the outer (female) end of corresponding first and second duct sections to be connected and sealed. A plurality of fasteners are used to connect the annular flange of the first connector to the annular flange of the second connector.

According to another embodiment, a method for connecting and sealing duct sections includes the steps of providing first and second flange connector and gasket assemblies in accordance with the invention, inserting the inner end of each first and second assembly into an outer end of corresponding first and second duct sections to be connected and sealed, and connecting the annular flange of the first connector to the annular flange of the second connector using a plurality of fasteners.

### BRIEF DESCRIPTION OF THE DRAWING

The drawing figures are not necessarily to scale, with the emphasis instead placed upon the principles of the invention. Additionally, each of the embodiments depicted are but one of a number of arrangements possible utilizing the fundamental concepts of the present invention. The drawings are briefly described as follows.

FIG. 1 shows a perspective view of an embodiment of a flange connector and gasket assembly for sealing the connection between round duct sections, in accordance with the invention.

FIG. 2 shows a cross-sectional view of the flange connector and gasket assembly shown in FIG. 1.

FIG. 3 shows a perspective view of an embodiment of a flange connector and gasket assembly for sealing the connection between duct sections, in use between a pair of round duct sections.

FIG. 4 shows a cross-sectional view of the embodiment shown in FIG. 3, depicting the flexible hollow sealing portion in engagement with the inside of an outer (female) duct section, according to the contemplated use of the invention.

### DETAILED DESCRIPTION OF THE INVENTION

The following description relates to certain preferred embodiments of apparatus and methods for making and using a flange connector and gasket assembly system for connecting and sealing the joints between adjacent duct sections. It will be readily apparent that numerous variations and modifications, other than those specifically indicated, will be readily apparent to those of sufficient skill in the art. In addition, certain terms are used throughout the discussion in order to provide a convenient frame of reference with regard to the accompanying drawings, such as “inside”, “outside”, and the like. Such terms are not intended to be specifically limiting of the invention, except where so indicated in the claims.

The invention provides a flange connector and gasket assembly system for sealing various types of connections between duct sections. The invention provides for the maintenance of a gas-tight seal between tubular duct members that are connected. The flange connector and gasket assembly is adapted for use with conventional duct sections and/or connectors, providing an additional barrier to gas transfer into or out of the connected ducts.

Such joint assemblies generally comprise one or more connections, wherein a first tubular member (such as, e.g., a round or round-oval duct section, or connector therefore), having an outside diameter incrementally smaller than the inside diameter of a second tubular member, is engaged with the second tubular member by inserting a portion of an end of the first tubular member into a portion of an end of the second tubular member. The term “inner end” generally refers to a male fitting and “outer end” generally refers to a female fitting.

The preferred embodiment includes a flange connector and gasket assembly for connecting and sealing duct sections, comprising a tubular member having an inner (male) end incrementally smaller than the inside diameter of the outer (female) end of a duct section to be joined and sealed, and a gasket-seating trough adjacent to the inner end for receiving a sealing gasket. An annular flange extends radially outward from the outer end of the tubular member, the outer perimeter of the annular flange having a rolled edge that is rolled back toward the inner end of the tubular member. A sealing gasket is secured to the gasket-seating trough of the tubular member for sealing the duct section to be connected, the sealing gasket including a substantially flat base portion having, preferably having a substantially I-shaped, J-shaped or L-shaped cross-section, and a flexible hollow sealing portion of substantially circular cross-sectional shape affixed to and extending radially outward from the flat base portion for engagement with an outer end of the duct section to be connected and sealed.

In the preferred embodiment, the sealing gasket base portion and the flexible hollow sealing portion comprise materials having different hardness, the flexible hollow sealing portion preferably being softer than the base portion. Preferably, the sealing gasket is permanently secured to the gasket-seating trough of the tubular member by crimping the inner edge of the tubular member onto the edge of the sealing gasket base portion. The sealing gasket base portion therefore should be flat on at least the underside, but should be substantially flat on both sides, especially at the outer edge, where the metal is crimped over onto the gasket base. However, the sealing gasket base portion optionally includes a substantially I-shaped, J-shaped or L-shaped cross-section, which can provide a lip on the inner edge of the base. With respect to the claims, I-shaped, J-shaped or L-shaped cross-sections are intended to fall within the scope of a substantially flat base portion, as long as the base has a substantially flat portion, which is sufficient to allow the metal edge to secure the gasket. Indeed, the cross section of the base portion is not especially critical, as long as it is substantially flat at the edge, where it is fastened onto the tubular member. However, it may be desirable in some instances to include a lip on the inner edge of the sealing gasket base portion, such as for providing an additional surface for contacting the duct section to be sealed.

The invention further provides a flange connector and gasket assembly system for connecting and sealing duct sections, comprising first and second flange connector and gasket assemblies in accordance with the invention, wherein the inner end of each first and second assembly is fitted into an outer end of corresponding first and second duct sections to be connected and sealed, and a plurality of fasteners connect the annular flange of the first connector to the annular flange of the second connector.

The invention further provides a method for connecting and sealing duct sections, including the steps of providing first and second flange connector and gasket assemblies in accordance with the invention, inserting the inner end of each first and second assembly into an outer end of corresponding first and second duct sections to be connected and sealed, and connecting the annular flange of the first connector to the annular flange of the second connector using a plurality of fasteners.

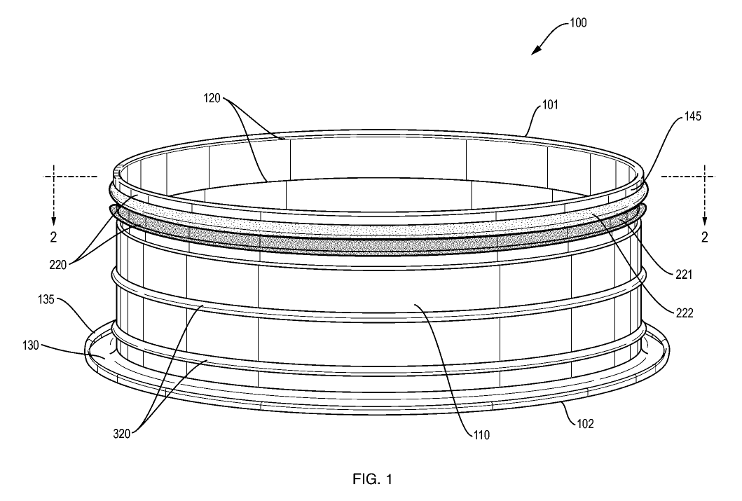

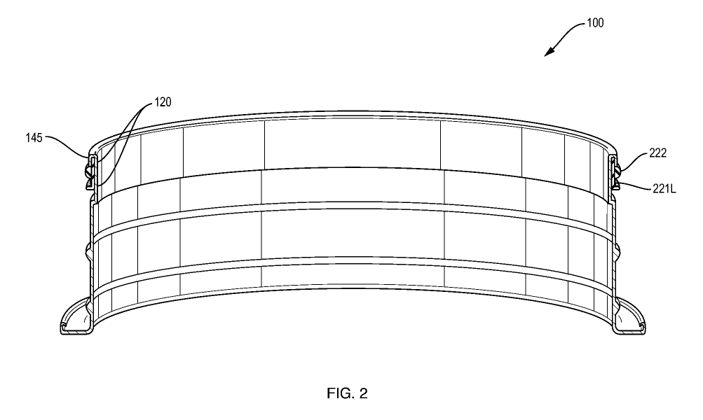

FIG. 1 shows a perspective view of an embodiment of a flange connector and gasket assembly for sealing the connection between round duct sections, constructed in accordance with the principles of the invention. Referring now to FIGS. 1 and 2 generally, the flange connector and gasket assembly 100 includes a tubular member 110 having an inner end 101 that is incrementally smaller than its outer end 102, and a gasket-seating trough 120 adjacent to the inner end 101 for receiving a sealing gasket 220. The tubular member 110 further includes an annular flange 130, extending radially outward from the outer end 102 of the tubular member. The outer perimeter of the annular flange 130 has a rolled edge 135 that is rolled back toward the inner end 101 of the tubular member. A sealing gasket 220 is secured onto the gasket-seating trough 120 of the tubular member for sealing the duct section to be connected. The tubular member optionally includes one or more ribs 330 for contacting the inside of the duct section to be connected, as this can improve the rigidity of the connection.

FIG. 2 shows a cross-sectional view of the flange connector and gasket assembly depicted in FIG. 1. The sealing gasket 220 includes a flat base portion 221, preferably having a substantially J-shaped or L-shaped cross-section 221L, and a flexible hollow sealing portion 222 of substantially circular cross-sectional shape affixed to the flat base portion and protruding in a radially outward direction. In the preferred embodiment, the sealing gasket base portion 221 and sealing portion 222 are manufactured from different materials, the flexible hollow sealing portion 222 preferably being softer than the base portion 221. FIG. 2 also more clearly shows the annular flange 130 and its rolled edge 135.

Referring now to FIG. 2, in the preferred embodiment of the flange connector and gasket assembly, the sealing gasket 220 is permanently secured to the gasket-seating trough 120 of the tubular member by crimping the inner edge 145 of the tubular member over onto the edge of the sealing gasket flat base portion 221. FIG. 2 also more clearly shows the L-shaped cross-section 221L of the sealing gasket base portion.

The flange connector and gasket assembly can be mass produced by machine, in the various common standard sizes, according to methods that are well known in the art. For instance, the following example describes a two-step process to produce a preferred embodiment of the flange connector and gasket assembly.

Step #1) Thin gauge (22-20) galvanized sheet metal is cut to length and rolled on a sheet metal roller into specific diameters (e.g., for common round duct sizes 4″-36″ nominal), thus initially forming the tubular member. The cut ends of the tubular member are then welded, preferably by means of a stitch welding. A bead is located on the part at the welded joint location to ensure a proper part that will meet quality control standards. A sealing gasket is fitted onto the tubular member and the partially assembled part is then placed on a hydraulic driven die. The part is set in motion on a horizontal spinning axis from counter-clockwise rotation. A forming wheel is set in motion from a air over oil cylinder to move into the spinning die, the part is formed with an offset and a 90 degree hem, and the forming wheel is retracted to a home position. An air operated cylinder is then set into motion to lower the sealing gasket into place against the 90 degree hem. The last operation is for a second cylinder to move into the die to close the hem of sheet metal tightly to hold the sealing gasket in place.

Step #2) The partially assembled part is then removed from the die and replaced in the opposite or 180 degree orientation relative to Step #1 above, and the bead formed in Step #1 is located. Air cylinders that move a forming tool into place perform a 1 ½″ flange that is pulled away from the die. After this sequence a second cylinder moves into the die to form a rolled ¼″ bead at the edge of the flange. At this point the part is complete ready to be installed.

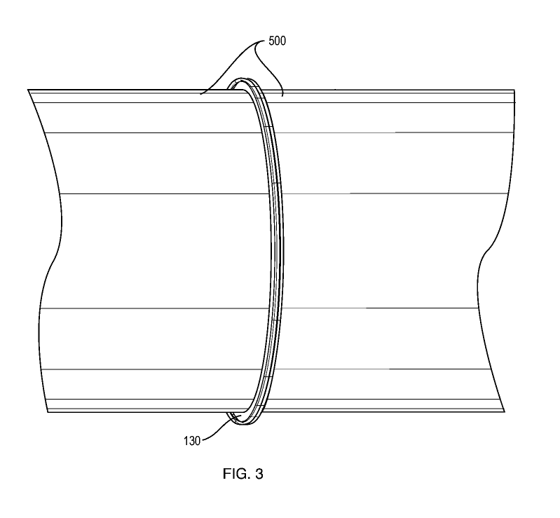

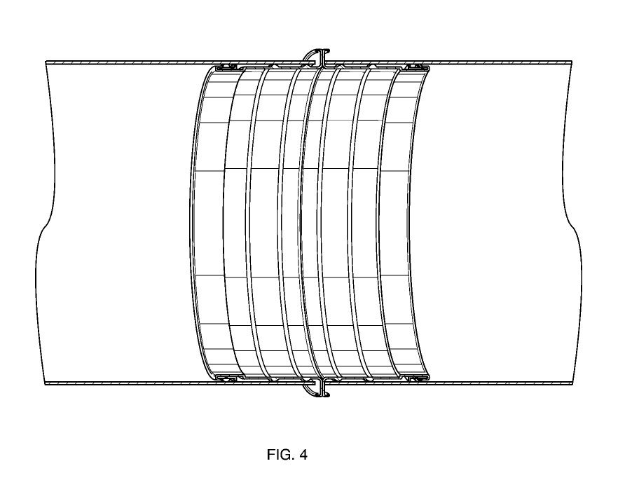

FIG. 3 shows a perspective view of an embodiment of a flange connector and gasket assembly for sealing the connection between duct sections, in use between a pair of round duct sections 500. FIG. 4 shows a cross-sectional view of the embodiment shown in FIG. 3, depicting the flexible hollow sealing portion in engagement with the inside of an outer (female) duct section, according to the contemplated use of the invention. Typically, two duct sections are joined using the flange connector and gasket assembly in the following manner.

First and second flange connector and gasket assemblies in accordance with the invention are provided. The inner end of each first and second assembly is inserted into an outer end of corresponding first and second duct sections to be connected and sealed. The annular flange of the first connector is then aligned face-to-face with to the annular flange of the second connector and the flanges are fastened together using a plurality of fasteners through the opposing flanges.

The advantages of the present invention provide an improvement over prior art duct sealing means. For example, the flange connector and gasket assembly of the present invention is adapted for use with conventional duct sections, providing an additional barrier to gas transfer into or out of the connected ducts. Gaskets do not need to be fitted onto the duct connectors in the field, reducing the chance of errors. Furthermore, duct sealer is not required when the present invention is employed, hence, excess duct sealer does not foul the perimeter of the apparatus. Thus, the invention overcomes the disadvantages of the prior art.

It is to be understood that the architectural and operational embodiments described herein are exemplary of a plurality of possible arrangements to provide the same (or equivalent) general features, characteristics, and general system operation. Therefore, while there have been described the currently preferred embodiments of the present invention, those skilled in the art will recognize that other and further modifications may be made, without departing from the spirit of the present invention, and it is intended to claim all modifications and variations as fall within the scope of the appended claims. It must further be understood that the embodiments of the invention herein described are merely illustrative of the application of the principles of the invention. Reference to the details of the illustrated embodiments is not intended to limit the scope of the claims, which themselves recite the features regarded as essential to the invention.

What is claimed is:

1. A flange connector and gasket assembly for connecting and sealing duct sections, comprising:
(a) a tubular member having an inner end that is incrementally smaller than an inside diameter of an outer end of a duct section to be connected and sealed;
(b) a gasket-seating trough adjacent to the inner end of the tubular member for receiving a sealing gasket;
(c) an annular flange, extending radially outward from an outer end of the tubular member, an outer perimeter of the annular flange having a rolled edge that is rolled back toward the inner end of the tubular member; and
(d) a sealing gasket secured to the gasket-seating trough of the tubular member for sealing the duct section to be connected, wherein the sealing gasket includes
i. a substantially flat base portion; and
ii. a flexible sealing portion of substantially circular cross-sectional shape affixed to and extending radially outward from the base portion for engagement with an outer end of the duct section to be connected and sealed.

2. The flange connector and gasket assembly of claim 1, wherein the sealing gasket base portion includes a substantially I-shaped, J-shaped or L-shaped cross-section, and the flexible sealing portion is hollow.

3. The flange connector and gasket assembly of claim 2, wherein the sealing gasket base portion and the flexible hollow sealing portion comprise materials having different hardness.

4. The flange connector and gasket assembly of claim 3, wherein the sealing gasket base portion is harder than the flexible hollow sealing portion.

5. The flange connector and gasket assembly of claim 4, wherein the sealing gasket is removably secured to the gasket-seating trough of the tubular member.

6. The flange connector and gasket assembly of claim 4, wherein the sealing gasket is permanently secured to the gasket-seating trough of the tubular member.

7. The flange connector and gasket assembly of claim 6, wherein the sealing gasket is permanently secured to the gasket-seating trough of the tubular member by a hem on the inner edge of the tubular member, which secures the edge of the sealing gasket base portion.

8. A flange connector and gasket assembly system for connecting and sealing duct sections, comprising:
(a) first and second flange connector and gasket assemblies in accordance with claim 1;
(b) first and second duct sections to be connected and sealed, wherein the inner end of each first and second flange connector and gasket assembly is fitted into an outer end of the corresponding first and second duct sections to be connected and sealed; and
(c) wherein a plurality of fasteners connect the annular flange of the first connector to the annular flange of the second connector.

9. The flange connector and gasket assembly system of claim 8, wherein the sealing gasket base portion includes a substantially I-shaped, J-shaped or L-shaped cross-section, and the flexible sealing portion is hollow.

10. The flange connector and gasket assembly system of claim 9, wherein the sealing gasket base portion and the flexible hollow sealing portion comprise materials having different hardness.

11. The flange connector and gasket assembly system of claim 10, wherein the sealing gasket base portion is harder than the flexible hollow sealing portion.

12. The flange connector and gasket assembly system of claim 11, wherein the sealing gasket is removably secured to the gasket-seating trough of the tubular member.

13. The flange connector and gasket assembly system of claim 11, wherein the sealing gasket is permanently secured to the gasket-seating trough of the tubular member.

14. The flange connector and gasket assembly system of claim 13, wherein the sealing gasket is permanently secured to the gasket-seating trough of the tubular member by a hem on the inner edge of the tubular member, which secures the edge of the sealing gasket base portion.

15. A method for connecting and sealing duct sections, comprising the steps of:
(a) providing first and second flange connector and gasket assemblies in accordance with claim 1;
(b) inserting the inner end of each first and second assembly into an outer end of corresponding first and second duct sections to be connected and sealed; and
(c) connecting the annular flange of the first connector to the annular flange of the second connector using a plurality of fasteners.

16. The method of claim 15, wherein the sealing gasket base portion includes a substantially I-shaped, J-shaped or L-shaped cross-section, and the flexible sealing portion is hollow.

17. The method of claim 16, wherein the sealing gasket base portion and the flexible hollow sealing portion comprise materials having different hardness and the sealing gasket base portion is harder than the flexible hollow sealing portion.

18. The method of claim 17, wherein the sealing gasket is removably secured to the gasket-seating trough of the tubular member.

19. The method of claim 17, wherein the sealing gasket base portion is permanently secured to the gasket-seating trough of the tubular member.

20. The method of claim 19, wherein the sealing gasket is permanently secured to the gasket-seating trough of the tubular member by a hem on the inner edge of the tubular member, which secures the edge of the sealing gasket base portion.
